(19) United States
(12) Patent Application Publication
(10) Pub. No.: US 2024/0383602 A1
(43) Pub. Date: Nov. 21, 2024

(54) TILTROTOR AIRCRAFT

(71) Applicants: Sergey Kurilenko, Moscow (RU); Alexey Sobolev, Yekaterinburg (RU); Ziaur Rahman, Dubai (AE); Andrey Nikiforov, Key Colony Beach, FL (US)

(72) Inventors: Sergey Kurilenko, Moscow (RU); Alexey Sobolev, Yekaterinburg (RU); Ziaur Rahman, Dubai (AE); Andrey Nikiforov, Key Colony Beach, FL (US)

(21) Appl. No.: 18/773,226

(22) Filed: Jul. 15, 2024

Related U.S. Application Data
(60) Provisional application No. 63/466,661, filed on May 15, 2023.

(51) Int. Cl. B64C 29/00; B64D 27/40

(52) U.S. Cl. CPC B64C 29/0033; B64D 27/402; B64D 27/406

(57) ABSTRACT

A tiltrotor aircraft is provided having a fuselage and a wing. The tiltrotor aircraft includes a node with a tilt mechanism mechanically coupled to one of the fuselage or the wing, a pylon mechanically coupled to the tilt mechanism at a first end and to a motor at a second end, and a rotor mechanically coupled to the motor, wherein the node provides thrust force balance above and below the wing. The tilt mechanism is actuated to enable vertical and horizontal flight. Furthermore, the node is force and torque balanced about an axis of rotation of the fuselage.

### CROSS-REFERENCE TO RELATED APPLICATIONS

This application claims priority to U.S. Provisional Patent Application Ser. No. 63/466,661 filed on May 15, 2023, the complete disclosure of which is incorporated herein by reference in its entirety.

### FIELD OF THE TECHNOLOGY

This disclosure relates generally to aircraft, more particularly to tilt-rotor, vertical lift aircraft, and still more particularly to a tilt-rotor, vertical lift aircraft having a balanced node.

### BACKGROUND OF THE TECHNOLOGY

A tilt-rotor, vertical lift aircraft generates both lift and propulsion by adjusting tilt-rotor assemblies coupled to the aircraft, wherein a tilt-rotor assembly includes a rotor that spins under engine power. The rotor may be tilted to adjust the rotor plane of rotation between horizontal and vertical planes relative to a wing. The rotor provides vertical lift to the aircraft when spinning in a horizontal plane of rotation relative to an upper wing surface. Furthermore, the rotor provides forward propulsion to the aircraft when spinning in a vertical plane of rotation relative to the upper wing surface. During forward propulsion, the fixed wings provide lift to the aircraft. Still further, the rotor may spin in any number of planes relative to the upper wing surface between the vertical and horizontal planes to provide a combination of lift and forward propulsion or thrust. According to one example, tilt-rotor, vertical lift aircraft provide vertical lift capabilities of a rotary-wing aircraft along with the speed of a conventional fixed-wing aircraft.

### BRIEF DESCRIPTION OF THE DRAWINGS

The technology can be more fully understood by reading the following detailed description together with the accompanying drawings, in which like reference indicators are used to designate like elements. The drawings illustrate several examples of the technology. It should be understood, however, that the technology is not limited to the precise arrangement and configurations shown. In the drawings:

FIG. 1 illustrates a tiltrotor aircraft in front perspective view having a pair of dual nodes configured for forward flight according to one example of the technology;

FIG. 2 illustrates a tiltrotor aircraft in front perspective view having a pair of dual nodes configured for vertical flight according to one example of the technology;

FIG. 3 illustrates a tiltrotor aircraft in top view having a pair of dual nodes configured for vertical flight according to one example of the technology;

FIG. 4 illustrates a tiltrotor aircraft in front perspective view having a quad node configuration for forward flight according to one example of the technology;

FIG. 5 illustrates a tiltrotor aircraft in front perspective view having a quad node configuration for vertical flight according to one example of the technology;

FIG. 6 illustrates a tiltrotor aircraft in top view having a quad node configuration for vertical flight according to one example of the technology;

FIG. 7 illustrates a tiltrotor aircraft in front view having a triple node configuration for forward flight according to one example of the technology;

FIG. 8 illustrates a tiltrotor aircraft in perspective view having a triple node configuration for horizontal forward flight with thrust forces identified according to one example of the technology;

FIG. 9 illustrates a tiltrotor aircraft in side view having a multi-node configuration for horizontal forward flight with thrust forces and rotational momentum identified according to one example of the technology;

FIG. 10 illustrates a tiltrotor aircraft in side view having a multi-node configuration for ascending forward flight with thrust forces and rotational momentum identified according to one example of the technology;

FIG. 11 illustrates a cross-sectional side view of an airfoil according to one example of the technology;

FIG. 12 illustrates a tiltrotor aircraft configured to generate electric power according to one example of the technology;

FIG. 13A illustrates a dual node configuration provided along a leading edge of a wing to pull an aircraft according to one example of the technology; and

FIG. 13B illustrates a dual node configuration provided along a trailing edge of a wing to push an aircraft according to one example of the technology.

### DETAILED DESCRIPTION OF THE TECHNOLOGY

What is needed is a tilt-rotor assembly having a balanced node that includes two or more rotors for placement anywhere along a wing or fuselage. It will be readily understood by persons skilled in the art that the present disclosure has broad utility and application. In addition to the specific examples described herein, one of ordinary skill in the art will appreciate that this disclosure supports various adaptations, variations, modifications, and equivalent arrangements.

It will be appreciated that for simplicity and clarity of illustration, where appropriate, reference numerals may be repeated among the different figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, methods, procedures, and components are not described in detail so as not to obscure the related relevant feature being described. Also, the description is not to be considered as limiting the scope of the examples described herein. The drawings are not necessarily drawn to scale and the proportions of certain parts may be exaggerated to better illustrate details and features of the present disclosure. Those skilled in the art with access to the teachings provided herein will recognize additional modifications, applications, and examples within the scope thereof and additional fields in which the technology would be of significant utility.

Unless defined otherwise, technical terms used herein have the same meaning as is commonly understood by one of ordinary skill in the art to which this disclosure belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and means either, any, several, or all of the listed items. The terms “comprising,” “including,” and “having” are used interchangeably in this disclosure. The terms “comprising,” “including,” and “having” mean to include, but are not necessarily limited to the things so described. The terms “connected” and “coupled” can be such that the objects are permanently connected or releasably connected. The term “substantially” is defined to be essentially conforming to the thing that it “substantially” modifies, such that the thing need not be exact. For example, substantially 2 inches (2″) means that the dimension may include a slight variation.

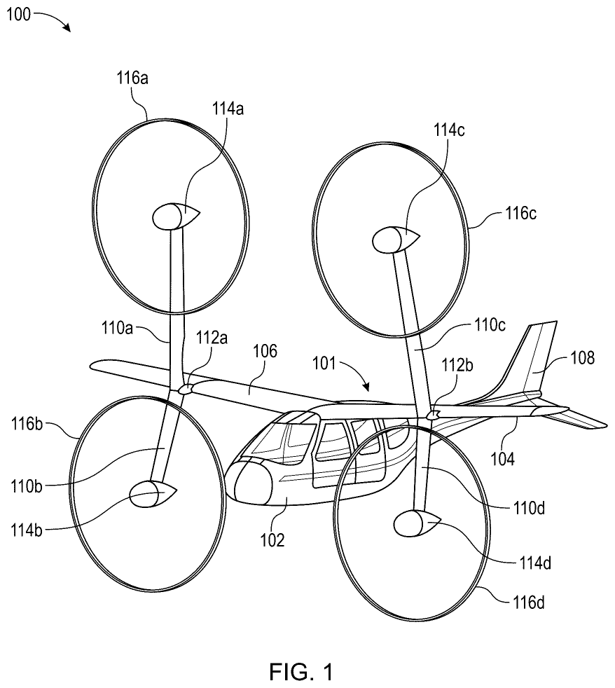

FIG. 1 illustrates a tiltrotor aircraft 100 configured for forward flight according to one example of the technology. The tiltrotor aircraft 100 includes an airframe 101 having a fuselage 102, a left wing 104, a right wing 106, and an empennage 108, among other components. The airframe 101 structurally supports the aircraft 100 when subjected to various structural stresses including aerodynamic forces, gravitational forces, thrust forces, or the like. The fuselage 102 is a main body of an airframe 101 that defines a three-dimensional space configured to transport pilots, passengers, cargo, and the like. According to one example, the fuselage 102 may include a nose end and a tail end. The nose end refers to portions of the fuselage 102 forward of the wings 104,106. The tail end refers to portions of the fuselage 102 aft of the wings 104,106. According to one example, the tail end may include a tail boom that connects to and structurally supports the empennage 108. According to one example, the tail boom may extend aft from the trailing edge of the wings 104,106 to the empennage 108.

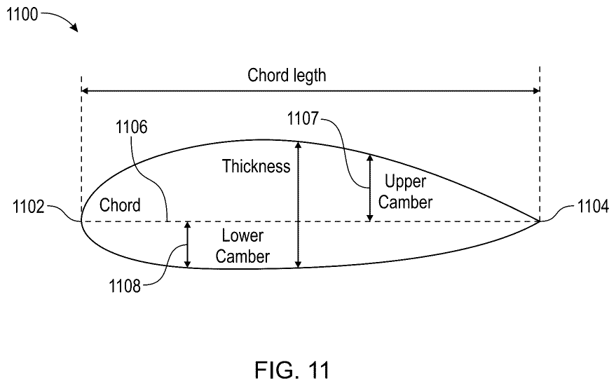

Components of the tiltrotor aircraft 100 that produce lift are generally called airfoils. For example, the wings 104,106 are airfoil structures that produce lift during forward flight. With reference to FIG. 11, a wing 1100 is a primary airfoil that includes a leading edge 1102, a trailing edge 1104, a chord 1106, an upper camber 1107, and a lower camber 1108, among other features. The leading edge 1102 is provided at a front portion of the wing 1100 that meets air first during flight. The trailing edge 1104 is provided at a rear portion of the wing 1100, where airflow over the upper surface and lower surface of the wing 1100 recombine. The chord 1106 is an imaginary straight line drawn through the wing 1100 between the leading edge 1102 and the trailing edge 1104. The wing camber is a curved surface defined on the upper and lower surfaces of the wing 1100. For example, the upper camber 1107 corresponds to an upper surface and the lower camber 1108 corresponds to a lower surface of the wing 1100. The curve is measured by how much a surface departs from the chord 1106 of the wing 1100. For example, a wing appears flat with little camber and curved with a high degree of camber.

According to one example, the wings 104,106 include a structural member called a spar that runs spanwise at right angles to the fuselage. The spar carries flight loads and the weight of the wing while the aircraft is on the ground. The wing may include other structural and forming members such as ribs mechanically coupled to the spar. According to one example, the ribs may extend in a direction from the leading to trailing edges of the wing. According to one example, the wings 104,106 may house components such as power distribution systems, control instruction distribution components, fuel tanks, or the like. According to one example, the fuel tanks may store fossil fuel to power a combustion engine for flight, onboard power generation, or the like. According to one example, the combustion engine may support hybrid operation. According to one example, the power distribution systems may include batteries, computer processors, cables, circuit boards, or the like. According to one example, the control instruction distribution components may include electrical signal cables for electronic systems, mechanical linkages, or the like. The empennage 108 is an arrangement of stabilizing surfaces at the tail of the airframe 101. According to one example, the empennage 108 may extend upward from the tail boom. According to one example, the wings 104,106 are coupled to the fuselage 102 at a location forward of the empennage 108. According to one example, the airframe 101 may be manufactured from various materials suitable for aviation structures such as aluminum alloys, steel alloys, composite materials, or the like. According to one example, the materials used to construct the airframe 101 may be coated with various coatings such as paint, low friction coatings, or the like.

According to one example, the wings 104,106 and/or the empennage 108 may be configured to structurally support various node configurations such as a single node, dual nodes, triple nodes, quad nodes, or the like, among other node configurations. Furthermore, the wings 104,106, empennage 108, and nodes may operate together to provide stability during takeoff, landing, and flight. According to one example, a node includes an assembly of components including at least a rotor, a pylon, a motor, and a tilt actuator or tilt mechanism. According to one example, multiple rotors or propellers may be provided per node to balance thrust forces and torque produced while spinning. According to one example, balancing thrust forces and torque while the rotors are spinning allows the nodes to be placed at any of various locations throughout the aircraft 100. For example, the nodes may be placed along a leading wing portion proximate to the leading edge of the wings 104,106, along a trailing wing portion proximate to the trailing edge of the wings 104,106, along the empennage 108, or the like.

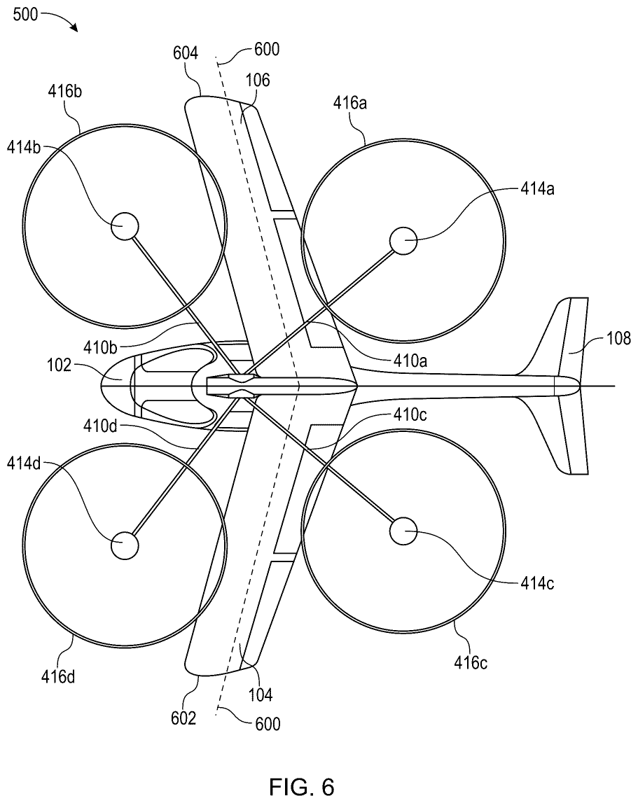

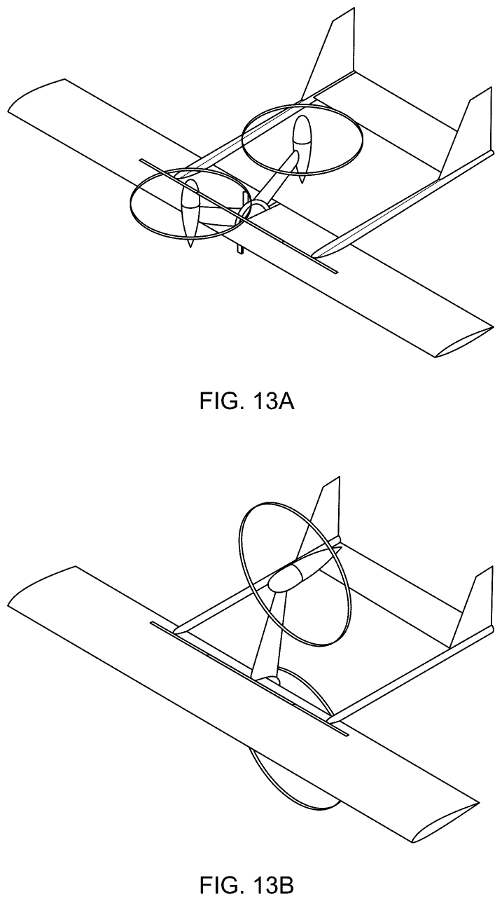

FIG. 13A illustrates one example of an aircraft having a dual node provided along a leading wing portion proximate to the leading edge of the wing to pull the aircraft. According to one example, the tilt mechanism may be mechanically coupled to the spar or rib structures embedded within the wings. For example, the node may be mechanically coupled using bolts, rivets, welding, epoxy, or the like. According to one example, nodes are placed between the tips 602,604 of wings 104,106, respectively, as illustrated in FIG. 6 such that the rotors substantially span the wings 104,106 to allow the rotors to generate airflow that passes above and below the wings 104,106. To the extent nodes are placed at the wing tips 602,604, the pylons may be angled inward toward the fuselage 102 such that the rotors substantially span the wings 104,106 to allow the rotors to generate airflow that passes above and below the wings 104,106. Stated differently, the rotors are not placed outside the span of wings 104,106 to generate airflow that does not at least partially pass above and below the wings 104,106. According to one example, the rotors may be placed entirely over the wings 104,106 to generate airflow that passes above and below the wings 104,106. According to one example, the tilt mechanism may include a housing shaped similar to the wing contour. When the node is positioned for forward flight, the tilt mechanism housing may conform to the wing shape to improve aerodynamic performance. FIG. 13B illustrates one example of an aircraft having a dual node provided along a trailing wing portion proximate to the trailing edge of the wing to push the aircraft. In FIGS. 13A and 13B, the reference line drawn across the wing surface illustrates the general placement of the node between the leading and trailing edges.

According to one example, a dual node configuration may include two rotors per tilt mechanism; a quad node configuration may include four rotors per tilt mechanism; the triple node configuration may include three rotors per tilt mechanism; and the single node configuration may include one rotor per tilt mechanism. According to one example, the various node configurations are designed to produce balanced thrust forces above and below the wings 104,106. As described in greater detail below, balancing thrust forces for each node may be accomplished in several ways including tilt mechanism placement along the wings or fuselage; setting pylon lengths, rotor diameters, rotor blade shapes, rotor blade lengths; adjusting rotor rotation speed; adjusting node attack angles, among modifying other characteristics.

FIG. 1 illustrates one example of a dual node configuration provided on each of the wings 104,106 to pull the tiltrotor aircraft 100. According to one example, each dual node is thrust force balanced within itself. For example, the dual node associated with the tilt mechanism 112a, the pylons 110a, 110b, the motors 114a, 114b, and the rotors 116a, 116b is thrust balanced above and below the wing 106. Specifically, the pylons 110a, 110b are substantially identical, the motors 114a, 114b are substantially identical, and the rotors 116a,116b are substantially identical. According to one example, the substantially identical components ensure the thrust forces are substantially balanced above and below the wing 106.

Similarly, the dual node associated with the tilt mechanism 112b, the pylons 110c, 110d, the motors 114c, 114d, and the rotors 116c, 116d is balanced above and below the wing 106. Specifically, the pylons 110c, 110d are substantially identical, the motors 114c, 114d are substantially identical, and the rotors 116c, 116d are substantially identical. According to one example, the substantially identical components ensure the thrust forces are substantially balanced above and below the wing 104. Furthermore, each dual node is force and torque balanced relative to the other dual node. According to one example, force balancing two or more nodes on an aircraft includes weight (force=mass×gravity) balancing. For example, each of the substantially identical dual nodes may be positioned along a wing portion at substantially identical distances from the wing tips and fuselage to force or weight balance. However, if one dual node generates more force (e.g., weighs more) than the other dual node, the dual nodes may be offset from the wing tips and fuselage by different distances. For example, the lighter dual node may be placed further from the fuselage to force balance the nodes.

According to one example, each wing 104,106 may be configured to structurally support the pair of dual nodes having thrust assemblies or pylons 110a/110b and 110c/110d. For example, the spar or ribs associated with wing 106 may structurally support the pylons 110a, 110b via tilt mechanism 112a, while the spar or ribs associated with wing 104 may structurally support pylons 110c, 110d via tilt mechanism 112b. According to one example, each pair of pylons 110a/110b and 110c/110d may be coupled to a corresponding tilt mechanism 112a, 112b that mechanically tilts corresponding rotors 116a-d.

According to one example, each dual node may include a corresponding tilt mechanism 112a, 112b that is mechanically coupled to corresponding pylons 110a-d that structurally support corresponding motors 114a-d and corresponding rotors 116a-d. For example, the tilt mechanism 112a is mechanically coupled to pylons 110a, 110b to structurally support corresponding motors 114a, 114b and rotors 116a, 116b. According to one example, FIG. 1 includes a second tilt mechanism 112b that is mechanically coupled to pylons 110c, 110d to structurally support corresponding motors 114c, 114d and rotors 116c,116d. According to one example, a computer processor may execute a program having instructions that orient the tilt mechanisms 112a, 112b in a hover configuration, a forward configuration, or a combination of hover and forward configurations. According to one example, the forward configuration allows the tiltrotor aircraft 100 to produce horizontal thrust for horizontal takeoff and landing, if desired. Alternatively or additionally, the tilt mechanisms 112a, 112b may be oriented in the forward configuration to allow the aircraft 100 to fly in a forward mode similar to a fixed-wing airplane.

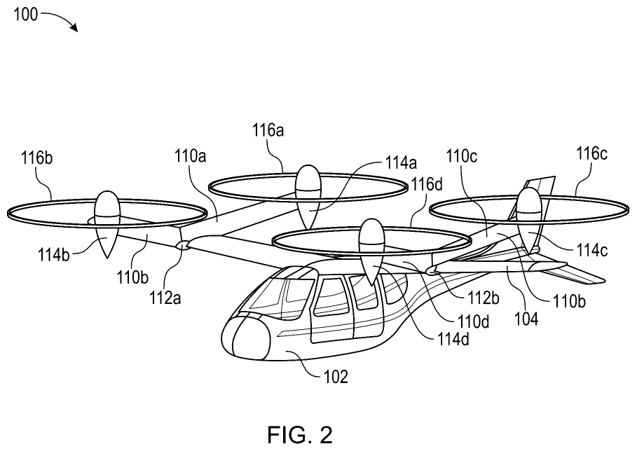

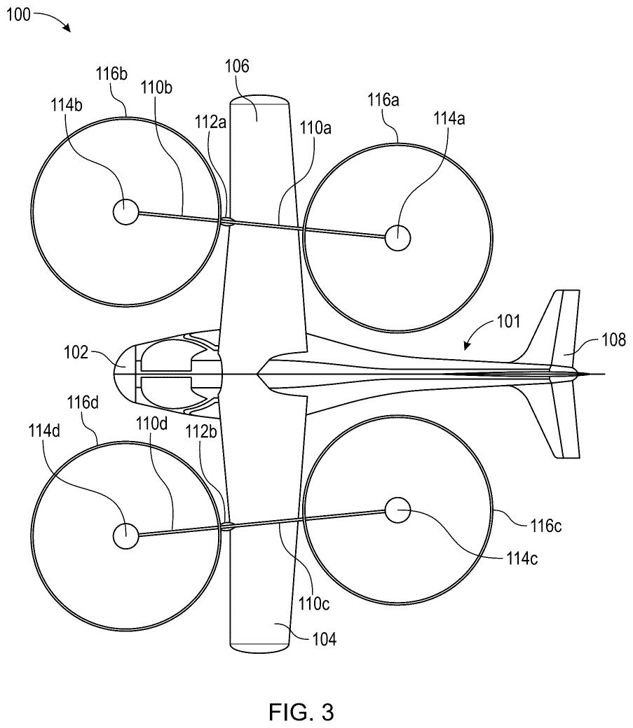

With reference to FIGS. 2 and 3, the tilt mechanisms 112a, 112b may be oriented so the corresponding rotors 116a-d are provided in a hover configuration. According to one example, the hover configuration allows the tiltrotor aircraft 100 to produce vertical thrust for vertical takeoff and landing. Alternatively or additionally, the tilt mechanisms 112a, 112b may be oriented in the hover configuration to allow the aircraft 100 to perform substantially stationary hovering in a hover mode similar to a rotary-wing helicopter. According to one example, the tiltrotor aircraft 100 may operate in a combination of hover and forward modes to produce both vertical and forward thrust.

According to one example, each pylon 110a-d may include a corresponding rotor 116a-d that is mechanically coupled to a corresponding motor 114a-d. According to one example, the motors 114a-d may include electric motors that rotate corresponding rotors 116a-d as electrical energy is converted into rotational kinetic energy. According to one example, the rotors 116a-d convert the rotational kinetic energy into aerodynamic forces that propel the aircraft 100. According to one example, the rotors 116a-d may include several propeller blades or airfoils and a head with a hub and linkages, among other components. According to one example, the rotors 116a-d may be fixed pitch, variable pitch, or a combination of fixed pitch and variable pitch. According to one example, the rotors 116a-d may be articulated into a negative angle of attack to produce reverse thrust without changing a direction of rotation of the rotors 116a-d. According to one example, the rotors 116a-d may define any suitable disc area. Furthermore, the rotors 116a-d may define any desired cross section or twist angle based on blade span.

According to one example, the tilt mechanisms 112a, 112b may be actuated to tilt the corresponding pylons 110a-d and orient the rotors 116a-d between the hover and forward configurations. According to one example, a computer processor may determine a rate the corresponding tilt mechanism 112a, 112b tilts the associated rotors 116a-d. According to one example, the tilt rate may be determined based on one or more factors such as propeller or rotor rotation speed, aircraft speed, or the like. According to one example, the tilt mechanisms 112a, 112b adjust an orientation of the corresponding rotors 116a-d between the hover and forward configurations or any suitable intermediate orientation between the hover and forward configurations. According to one example, the tilt mechanisms 112a, 112b may be configured to maintain an orientation of the corresponding rotors 116a-d in any desired position. According to one example, the tilt mechanisms 112a, 112b may offset corresponding rotors 116a-d from a plane of the wing to minimize download on surfaces of the aircraft 100. According to one example, the tilt mechanisms 112a, 112b may be configured to provide different orientations to the corresponding rotors 116a-d. For example, the tilt mechanism 112a made orient rotors 116a, 116b at a first angle, while the tilt mechanism 112b made orient rotors 116c, 116d at a second angle that is different from the first angle.

According to one example, the motors 114a-d may include electric motors that rotate corresponding rotors 116a-d. According to one example, the motors 114a-d may be directly connected to corresponding rotors 116a-d. Alternatively, the motors 114a-d may be connected to corresponding rotors 116a-d through a power transmission linkage such as a gearbox, clutch, or the like. According to one example, the electric motors may include a stator and a rotor that is integral with the rotors 116a-d. According to one example, the electric motors may be electromagnetic motors, electrostatic motors, piezoelectric motors, or any other suitable type of electric motor that transforms electric potential into rotational kinetic energy. According to one example, the electric motors may be self-commutated motors or externally commutated motors. For example, self-commutated motors may include brushed DC motors, brushless DC motors, a switched reluctance motor, an AC-DC motor, or the like. Externally commutated motors may include induction motors, torque motors, synchronous motors, doubly-fed electric motors, singly-fed electric motors, or the like. Still further, the electric motors may include a coreless rotor motor, an axial rotor motor, a stepper motor, or the like.

According to one example, the motors 114a-d may include combustion, hybrid, or electric motors. According to one example, the motors 114a-d may include a motor controller that is electrically coupled to a corresponding motor 114a-d. According to one example, a power source may be coupled to the motors 114a-d. For example, an electric power source may be electrically coupled to the motors 114a-d, the motor controller, and other components associated with the motors 114a-d such as thermal management components, lubrication components, feedback controllers, or the like. Alternatively, a power source may be fluidly coupled to the motors 114a-d. According to one example, the motor controller may be positioned proximate to the motors 114a-d or distal from the motors 114a-d. According to one example, the electric power source may be positioned proximate to the motors 114a-d or distal from the motors 114a-d. According to one example, the aircraft 100 may include a plurality of electric, combustion, or hybrid motors equal to the number of rotors. According to one example, two motors may be employed per rotor to increase safety and reliability. According to one example, counter-rotating rotors may be provided per pylon. For example, a pair of counter-rotating rotors may be provided per pylon.

According to one example, the power source may operate to power the motors 114a-d and any other components of the aircraft 100. According to one example, the power source may include fossil fuel to provide hybrid power through a combustion engine. According to one example, the combustion engine may be coupled to a power generator. According to one example, the electric power source may include one or more batteries, a fuel cell, a photovoltaic generator, or the like. According to one example, the aircraft 100 may include a power distribution system that couples the electric power source to each electrically powered component. According to one example, the power distribution system may include an electrical power transmission bus that distributes power from a plurality of electric power sources to electrical components associated with the aircraft 100. According to one example, the aircraft 100 may include various flight control elements that provide flight control and operation.

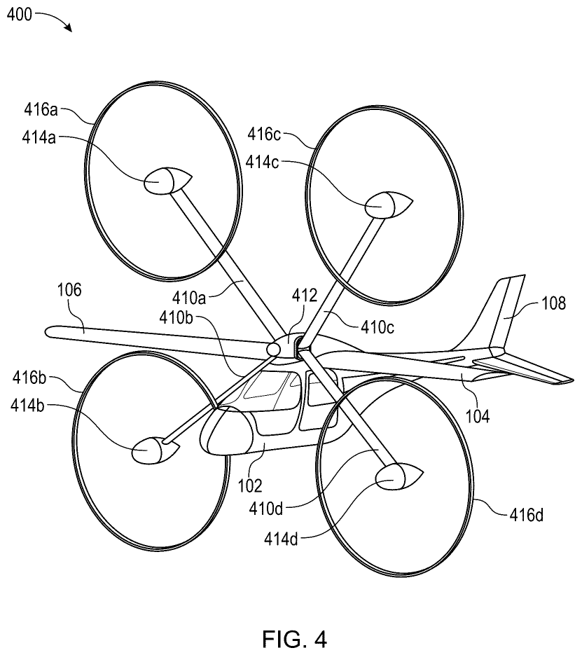

FIGS. 4-6 illustrate a tiltrotor aircraft 400 having a quad node configuration mechanically coupled to a roof support member on the fuselage 102. According to one example, the quad node is provided at a leading portion of the roof support member to pull the tiltrotor aircraft 400. According to one example, the quad node is thrust force balanced within itself. According to one example, the quad node includes a tilt mechanism 412 mechanically coupled to four pylons 410a-d that structurally support corresponding motors 414a-d and rotors 416a-d. According to one example, the quad node is thrust force balanced above and below the wings 104,106. According to one example, the four pylons 410a-d are substantially identical, the four motors 414a-d are substantially identical, and the four rotors 416a-d are substantially identical. Furthermore, the quad node is force and torque balanced about an axis of rotation of the fuselage 102. For example, the substantially equal quad node components are weight balanced on both sides of the fuselage 102.

According to one example, the tilt mechanisms 412 may be oriented in a hover configuration, a forward configuration, or a combination of hover and forward configurations. According to one example, the forward configuration allows the tiltrotor aircraft 400 to produce horizontal thrust for horizontal takeoff and landing, if desired. Alternatively or additionally, the tilt mechanisms 412 may be oriented in the forward configuration to allow the aircraft 400 to fly in a forward mode similar to a fixed-wing airplane.

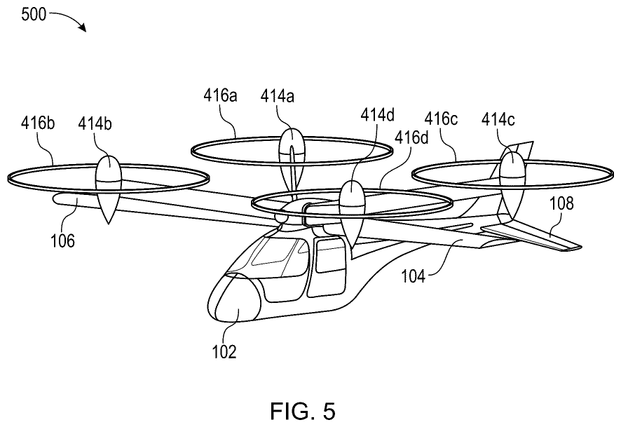

With reference to FIGS. 5 and 6, the tilt mechanisms 412 may be oriented so the motors 414a-d are provided in a hover configuration. According to one example, the hover configuration allows the tiltrotor aircraft 400 to produce vertical thrust for vertical takeoff and landing. Alternatively or additionally, the tilt mechanisms 412 may be oriented in the hover configuration to allow the aircraft 400 to perform substantially stationary hovering in a hover mode similar to a rotary-wing helicopter. According to one example, the tiltrotor aircraft 400 may operate in a combination of hover and forward modes to produce both vertical and forward thrust.

While FIGS. 4-6 illustrate the tilt mechanism 412 affixed to the roof support member proximate a leading edge of the wings 104,106 and centered above the fuselage 102, the technology contemplates placing the tilt mechanism 412 in other locations. For example, the tilt mechanism 412 may be positioned rearward of the roof support member toward a trailing edge of the wings 104,106. Reference line 600 generally delineates between the leading and trailing portions of the wings 104,106. Forward of reference line 600, between the leading edge and the reference line 600, corresponds to a leading portion. Aft of reference line 600, between the trailing edge and reference line 600, corresponds to a trailing portion. Placing a node within the leading portion pulls an aircraft, while placing a node within the trailing portion pushes an aircraft.

According to one example, each pylon 410a-d may be mechanically coupled to a corresponding motor 414a-d and rotor 416a-d. According to one example, the motors 414a-d may include motors that rotate corresponding rotors 416a-d to produce rotational kinetic energy. According to one example, the rotors 416a-d convert the rotational kinetic energy into aerodynamic forces that propel the aircraft 400. According to one example, the rotors 416a-d may include several propeller blades or airfoils and a head with a hub and linkages, among other components. According to one example, the rotors 416a-d may be fixed pitch, variable pitch, or a combination of fixed pitch and variable pitch. According to one example, the rotors 416a-d may be articulated into a negative angle of attack to produce reverse thrust without changing a direction of rotation of the rotors 416a-d. According to one example, the rotors 416a-d may define any suitable disc area. Furthermore, the rotors 416a-d may define any desired cross section or twist angle based on blade span.

According to one example, the tilt mechanism 412 may be actuated to tilt the pylons 410a-d and orient the rotors 416a-d between the hover and forward configurations. According to one example, a computer processor may determine a rate the tilt mechanism 412 tilts the rotors 416a-d. According to one example, the tilt rate may be determined based on one or more factors such as propeller or rotor rotation speed, aircraft speed, or the like. According to one example, the tilt mechanism 412 adjusts an orientation of the corresponding rotors 416a-d between the hover and forward configurations or any suitable intermediate orientation between the hover and forward configurations. According to one example, the tilt mechanism 412 may be configured to maintain an orientation of the corresponding rotors 416a-d in any desired position. According to one example, the tilt mechanism 412 may offset corresponding rotors 416a-d from a plane of the wing to minimize download on surfaces of the aircraft 400.

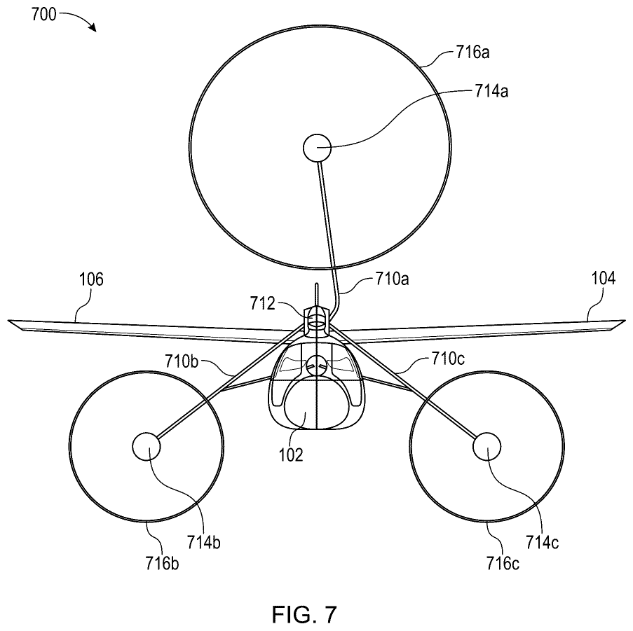

FIG. 7 illustrates a tiltrotor aircraft 700 having a triple node configuration mechanically coupled to a roof support member on the fuselage 102. According to one example, the triple node is provided at a leading portion of the roof support member to pull the tiltrotor aircraft 700. According to one example, the triple node is thrust force balanced within itself. According to one example, the triple node includes a tilt mechanism 712 mechanically coupled to three pylons 710a-c that structurally support corresponding motors 714a-c and rotors 716a-c. According to one example, the triple node is thrust force balanced above and below the wings 104,106. According to one example, the tilt mechanisms 712 may be oriented in a hover configuration, a forward configuration, or a combination of hover and forward configurations. According to one example, the forward configuration allows the tiltrotor aircraft 700 to produce horizontal thrust for horizontal takeoff and landing. Alternatively or additionally, the tilt mechanisms 712 may be oriented in the forward configuration to allow the aircraft 700 to fly in a forward mode similar to a fixed-wing airplane.

According to one example, the pylons 710a-c are mechanically coupled to corresponding motors 714a-c and rotors 716a-c. According to one example, the motors 714a-c may include electric motors that rotate corresponding rotors 716a-c as electrical energy is converted into rotational kinetic energy. According to one example, the rotors 716a-c convert the rotational kinetic energy into aerodynamic forces that propel the aircraft 700. According to one example, the rotors 716a-c may include several propeller blades or airfoils and a head with a hub and linkages, among other components. According to one example, the rotors 716a-c may be fixed pitch, variable pitch, or a combination of fixed pitch and variable pitch. According to one example, the rotors 716a-c may be articulated into a negative angle of attack to produce reverse thrust without changing a direction of rotation of the rotors 716a-c. According to one example, the rotors 716a-c may define any suitable disc area.

According to one example, the technology employs different techniques to balance thrust forces produced above and below the wings 104,106. For example, the technology may adjust pylon length. Additionally or alternatively, a computer may execute a program having instructions that adjust aspects of a node such as rotate the tilt mechanism, vary motor rotation speed, vary rotor diameter, vary rotor pitch, vary rotor blade shape, or the like. For example, the computer may execute a program having instructions that drive a motor to rotate the tilt mechanism. According to one example, a computer may execute a program having instructions that control characteristics of each rotor and/or motor individually to balance thrust forces produced above and below the wings 104,106. According to another example, a computer may execute a program having instructions that control characteristics of two or more rotors and/or motors simultaneously to balance thrust forces produced above and below the wings 104,106. According to one example, the technology may select rotor diameter, rotor blade shape, and pylon length for specific node configurations. According to one example, a computer may execute a program having instructions that vary one or more characteristics such as rotor diameter, rotor rotation speed, rotor blade shape, rotor attack angle relative to the wings, pylon length, or the like, in substantially real time to balance thrust forces produced above and below the wings 104,106. According to one example, a computer may execute a program having instructions that control motors associated with the rotors to vary rotation speed. According to another example, a computer may execute a program having instructions that control a motor associated with the tilt mechanism to vary the rotor attack angle. Still further, the computer may execute a program having instruction that control flaps and/or the empennage on the wings and tail to balance thrust forces.

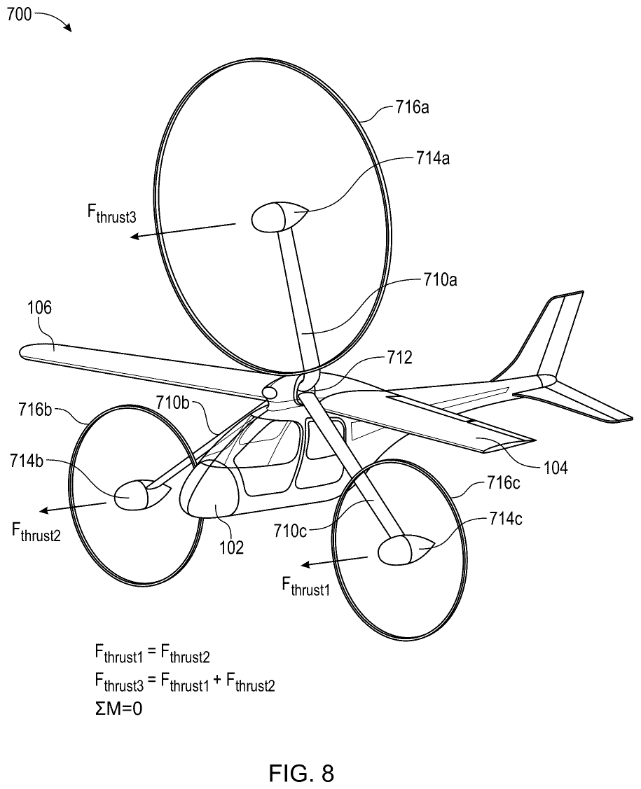

FIG. 8 illustrates one example of employing different rotor diameters above and below the wings 104,106 to balance thrust forces above and below the wings 104,106. According to one example, the pylons 710a-c are substantially equal length, rotors 716b, 716c are substantially equal dimensions, and rotor 716a is larger than rotors 716b,716c, which results in substantially balanced thrust forces above and below the wings 104,106. For example, the pylons 710b, 710c and the rotors 716b, 716c may be dimensioned to produce substantially identical thrust forces F_{thrust 1} and F_{thrust 2}. According to one example, the pylon 710a may be dimensioned substantially identical to the pylons 710b,710c. According to one example, the blades of rotor 716a may be dimensioned significantly larger than the blades of rotors 716b and 716c such that thrust force F_{thrust 3} equals the sum of thrust forces F_{thrust 1} and F_{thrust 2}. In this example, the motors 714a-c may spin at substantially equal speeds to provide substantially balanced thrust forces above and below the wings 104,106. According to one example, the blades of rotor 716a may be longer and/or wider than the blades of rotors 716b and 716c.

While not shown, the thrust forces F_{thrust 1}, F_{thrust 2}, F_{thrust 3}, may be balanced by increasing a length of the pylon 710a as compared to the lengths of pylons 710b,710c. In this case, with motors 714a-c spinning at substantially equal speeds, the blades of rotor 716a may be dimensioned substantially identical in size to the blades of rotors 716b and 716c such that thrust force F_{thrust 3} equals the sum of thrust forces F_{thrust 1} and F_{thrust 2}.

According to another example, two or more components may be adjusted to balance thrust forces. For example, the technology contemplates lengthening the pylon 710a, as compared to the lengths of pylons 710b, 710c, and also increasing the blade size of rotor 716a, as compared to the blade sizes of rotors 716b and 716c such that thrust force F_{thrust 3} equals the sum of thrust forces F_{thrust 1} and F_{thrust 2}. When two or more components are adjusted, changes to the individual components may be less drastic as compared to only changing one component. According to another example, the thrust forces may be balanced by adjusting a third component such as a rotation speed of the rotors 716a-c. For example, the dimensions of both the pylons 710a-c and the rotors 716a-c may be made more similar in size if a rotation speed of one or more rotors is adjusted to balance the thrust forces. For example, the rotation speed of the rotor 716a may be increased as compared to the rotation speeds of rotors 716b,716c to allow dimensioning the pylons 710a-c and the rotors 716a-c more similarly. One of ordinary skill in the art will readily appreciate that the rotors 716a-c may define any desired cross section or twist angle based on blade span.

According to one example, the tilt mechanism 712 may be actuated to tilt the pylons 710a-c and orient the rotors 716a-c between the hover and forward configurations. According to one example, a computer processor may determine a rate the tilt mechanism 712 tilts the rotors 716a-c. According to one example, the tilt rate may be determined based on one or more factors such as propeller or rotor rotation speed, aircraft speed, or the like. According to one example, the tilt mechanism 712 adjusts an orientation of the corresponding rotors 716a-c between the hover and forward configurations or any suitable intermediate orientation between the hover and forward configurations. According to one example, the tilt mechanism 712 may be configured to maintain an orientation of the corresponding rotors 716a-c in any desired position. According to one example, the tilt mechanism 712 may offset corresponding rotors 716a-c from a plane of the wing to minimize download on surfaces of the aircraft 700.

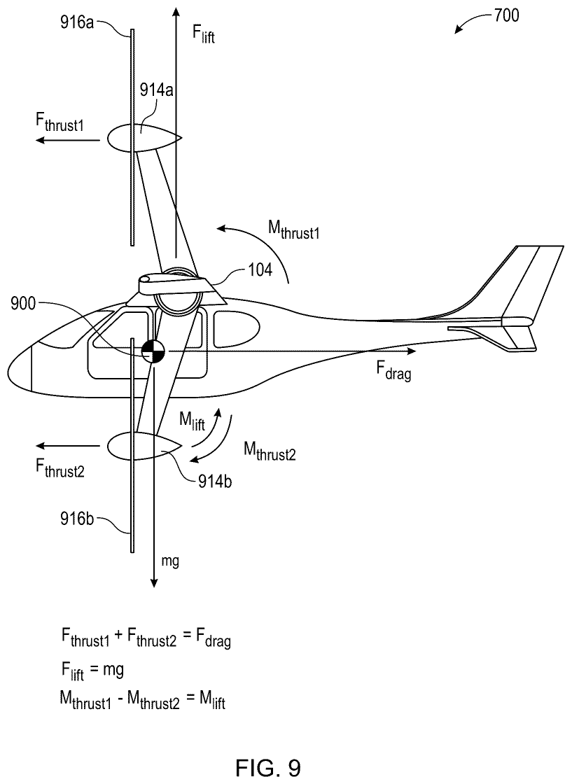

FIG. 9 illustrates the tiltrotor aircraft 700 flying in a horizontal orientation, neither ascending nor descending, according to one example of the technology. An axis of rotation 900 is identified about which thrust forces and torques acting on the tiltrotor aircraft 700 are calculated. According to one example, a gravity force (mg) acting on the tiltrotor aircraft 700 is counter-balanced by a lift force (F_{lift}) produced by air passing across or over the wings 104,106. The thrust forces generated by the motors 914a,914 and rotors 916a,916b are selected to counteract a drag force (F_{drag}) acting on the tiltrotor aircraft 700. Still further, a difference of the torques produced by the motors 914a, 914b (Mₜₕᵣᵤₛₜ₁−Mₜₕᵣᵤₛₜ₂) determines the torque M_{lift} acting on the tiltrotor aircraft 700. According to one example, a slight counterclockwise torque is applied to the tiltrotor aircraft 700 about the axis of rotation 900 to maintain the tiltrotor aircraft 700 in a horizontal position. According to one example, the torque produced by motors 914a,914b (Mₜₕᵣᵤₛₜ₁, Mₜₕᵣᵤₛₜ₂) could be substantially equal if the tiltrotor aircraft 700 body was symmetrical forward and aft of the wings 104,106.

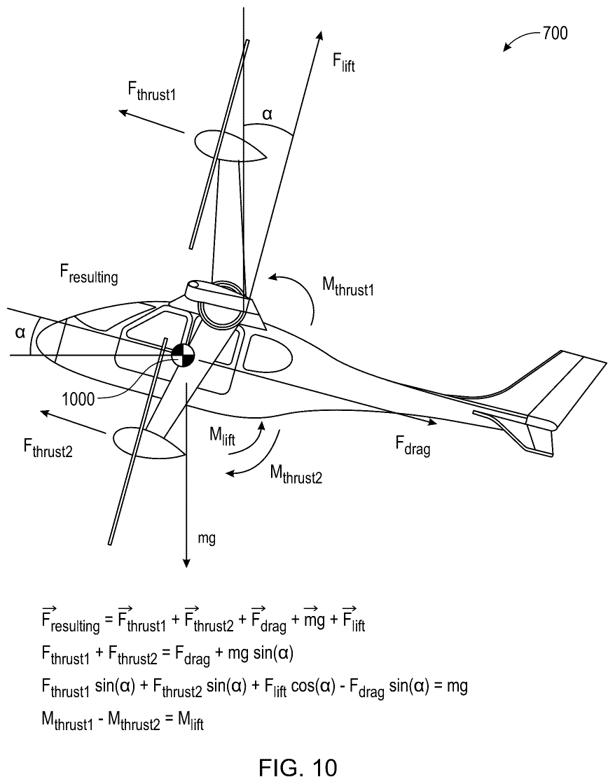

FIG. 10 illustrates the tiltrotor aircraft 700 ascending or flying upward according to one example of the technology. An axis of rotation 1000 is identified about which forces and torques acting on the tiltrotor aircraft 700 are calculated. According to one example, forces acting on the tiltrotor aircraft 700 form an angle α with respect to vertical and horizontal lines passing through the tiltrotor aircraft 700. According to one example, a gravity force (mg) acting on the tiltrotor aircraft 700 is counter-balanced by a sum of cosine of the lift force (F_{lift} cos α) produced by air passing across or over the wings 104,106, a sine of the thrust 1 force (F_{thrust 1} sine α), sine of the thrust 2 force (F_{thrust 2} sine α), minus a sine of the drag force (F_{drag} sine α). The thrust forces generated by the motors 914a,914 and the rotors 916a,916b are selected to counteract a drag force (F_{drag}) and sine of the gravity force (mg sin a) acting on the tiltrotor aircraft 700. A resulting force acting on the tiltrotor aircraft 700 includes a sum of thrust force F_{thrust 1}, thrust force F_{thrust 2}, drag force F_{drag}, gravity force F_{gravity}, and lift force F_{lift}. Still further, the difference of the torques produced by the motors 914a, 914b (Mₜₕᵣᵤₛₜ₁−Mₜₕᵣᵤₛₜ₂) determines the torque M_{lift} acting on the tiltrotor aircraft 700. According to one example, a slight counterclockwise torque is applied to the tiltrotor aircraft 700 about the axis of rotation 900 to maintain the tiltrotor aircraft 700 in an ascending position.

According to one example, the technology provides one or more balanced nodes that allow node placement anywhere along the wings 104, 106 or fuselage. According to one example, a single node may be employed when the single node is positioned above the fuselage roof as illustrated in FIGS. 4-8. According to another example, an even number of nodes may be employed when the nodes are force and torque balanced along a wing as illustrated in FIGS. 1-3. For example, if one node is placed on wing 104, then one node may be placed on wing 106; if two nodes are placed on wing 104, then two nodes may be placed on wing 106; and so on. Alternatively, a node with components having a larger gravity force (e.g., heavier components) may be counterbalanced using two or more nodes with components having a smaller gravity force (e.g. lighter components). A determination of where to place nodes along a wing or fuselage may be determined based on offsetting or balancing forces and torques. According to one example, a number of rotors per node may differ for each wing. For example, a triple node may be positioned on wing 104 and a force and torque balanced quad node may be positioned on wing 106. In this case, the forces and torques produced by the motors and rotors on each wing may be selected to counter-balanced each other.

According to one example, a method is provided for balancing a thrust force produced above and below the wing 104,106 of a tiltrotor aircraft that includes a node with a tilt mechanism mechanically coupled to first and second pylons, wherein each of the pylons is coupled to a motor and a rotor. According to one example, the first pylon is provided above the wing to extend a first motor and a first rotor above the wing. According to one example, the second pylon is provided below the wing to extend a second motor and a second rotor below the wing, wherein the first pylon is substantially identical to the second pylon, the first motor is substantially identical to the second motor, and the first rotor is substantially identical to the second rotor. According to one example, the method includes a second node having a second tilt mechanism mechanically coupled to third and fourth pylons, each of the third and fourth pylons being coupled to a motor and a rotor. According to one example, the third pylon is provided above the wing to extend a third motor and a third rotor above the wing. According to one example, the fourth pylon is provided below the wing to extend a fourth motor and a fourth rotor below the wing, wherein the third pylon is substantially identical to the fourth pylon, the third motor is substantially identical to the fourth motor, and the third rotor is substantially identical to the fourth rotor. According to one example, the first node and the second node are mechanically coupled to the wing on opposite sides of a fuselage. According to one example, the first node and the second node are force and torque balanced about an axis of rotation of the airframe. According to one example, the first rotor and the second rotor are provided entirely within the wingspan to generate airflow that passes above and below the wing. According to one example, all pylons are substantially identical, all motors are substantially identical, and all rotors are substantially identical.

According to another example, the various examples shown herein may be employed to generate electric power. For example, the various aircraft 100,400,700 may harness energy from air streams to generate electric power. For example, surface wind energy may grow rapidly with altitude up to around 10-12 km. According to one example, persistence of surface wind energy may vary based on an environment. For example, surface wind energy may be persistent over ocean environments and may be less persistent over urban or city environments. Above 12 km, high altitude jet streams are relatively persistent features of the mid-latitudes in both hemispheres. The various aircraft 100,400,700 may be employed to provide Airborne Wind Energy Systems (AWES). Most AWES systems rely on land anchoring to hold the aircraft 100,400,700 in a desired flight space and further employ a tether to transport electric power from rotors on the aircraft 100,400,700 to a ground station.

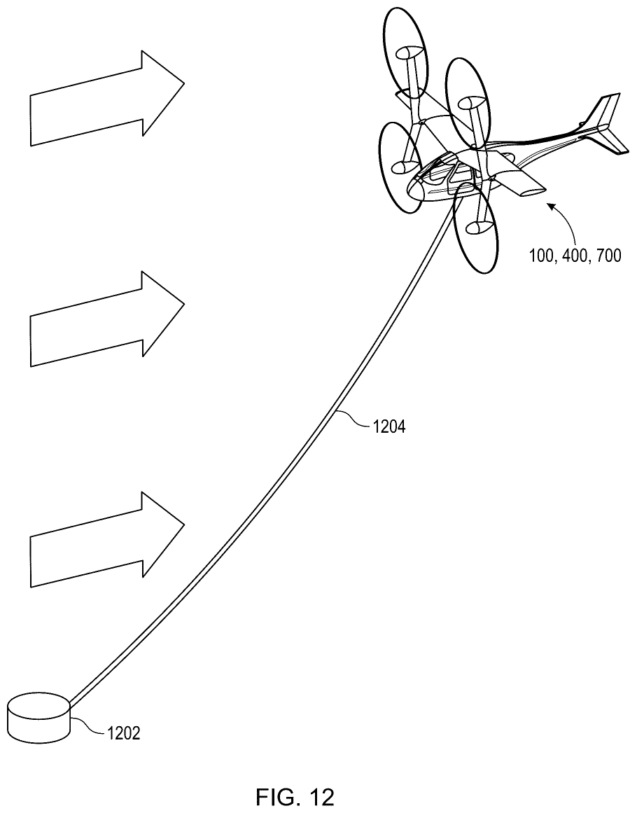

FIG. 12 illustrates one example of a system that may be employed to generate power from the aircraft 100,400,700. According to one example, a platform 1202 may be mechanically coupled to the aircraft 100,400,700 via a tether 1204 that may harness energy from wind (shown by arrows) that forces the rotors of the aircraft 100,400,700 to rotate. According to one example, the rotating rotors may generate a lift force that maintains the aircraft 100,400,700 in the air. According to one example, the aircraft rotors may be connected to a ground station via the tether 1204. According to one example, the tether 1204 may conduct electricity in two directions between the platform 1202 and the aircraft 100,400,700. According to one example, the tether 1204 provides an anchoring mechanism that holds the aircraft 100,400,700 in a desired flight space.

According to one example, each rotor of the aircraft 100,400,700 may be connected to the electric generator/motor. The rotors allow the aircraft 100,400,700 to ascend and descend in a controlled manner. According to one example, the aircraft 100,400,700 may ascend and descend in the absence of wind since power may be provided to the motor/generator. According to another example, the generator may be provided to harvest energy. According to one example, a portion of the power generated by the aircraft 100,400,700 may be employed by the aircraft 100,400,700 as needed. For example, power may be employed to illuminate the aircraft, maneuver the aircraft, or the like. A remainder of the power generated by the aircraft 100,400,700 may be stored as electric energy in the aircraft and/or transmitted to a facility located at the ground. For example, with wind speeds of 30 m/s, approximately 5-10% of the stream energy is employed to maintain levitation, while the remainder of the stream energy may be stored for other uses and/or transmitted to a facility located at the ground.

While the foregoing illustrates and describes examples of this technology, it is to be understood that the technology is not limited to the constructions disclosed herein. The technology may be embodied in other specific forms without departing from its spirit. For example, various modifications may be made without departing from the spirit and scope of the technology. The boundaries of the examples described herein have been arbitrarily defined for the convenience of the description. Alternate boundaries may be defined so long as the specified functions and relationships thereof are appropriately performed. For example, the methods, techniques, and systems for providing force and torque balanced nodes may be implemented using alternate techniques and may be applicable in other settings. Accordingly, the appended claims are not limited by specific examples described herein.

What is claimed is:

1. A tiltrotor aircraft having a fuselage and a wing, the tiltrotor aircraft comprising:
a node, having:
a tilt mechanism mechanically coupled to one of the fuselage or the wing;
a pylon mechanically coupled to the tilt mechanism at a first end and to a motor at a second end; and
a rotor mechanically coupled to the motor, wherein the node provides thrust force balance above and below the wing.

2. The tiltrotor aircraft according to claim 1, wherein the node is force and torque balanced about an axis of rotation of the fuselage.

3. The tiltrotor aircraft according to claim 1, wherein the node further comprises:
a second pylon mechanically coupled to the tilt mechanism at a first end and to a second motor at a second end; and
a second rotor mechanically coupled to the second motor, wherein the node provides thrust force balance above and below the wing.

4. The tiltrotor aircraft according to claim 3, wherein the node is force and torque balanced about an axis of rotation of the fuselage.

5. The tiltrotor aircraft according to claim 3, wherein the node further comprises:
a third pylon mechanically coupled to the tilt mechanism at a first end and to a third motor at a second end; and
a third rotor mechanically coupled to the third motor, wherein the node provides thrust force balance above and below the wing.

6. The tiltrotor aircraft according to claim 5, wherein the node is force and torque balanced about an axis of rotation of the fuselage.

7. The tiltrotor aircraft according to claim 5, wherein the rotor is provided above the wing and the second and third rotors are provided below the wings.

8. The tiltrotor aircraft according to claim 7, wherein the rotor is substantially larger than the second and third rotors.

9. The tiltrotor aircraft according to claim 7, wherein the rotor is programmed to spin faster than the second and third rotors.

10. The tiltrotor aircraft according to claim 7, wherein the pylon is substantially longer than the second and third pylons.

11. The tiltrotor aircraft according to claim 5, wherein the tilt mechanism is actuated to enable vertical flight.

12. The tiltrotor aircraft according to claim 5, wherein the tilt mechanism is actuated to enable horizontal flight.

13. A method for balancing a thrust force produced above and below a wing of an aircraft that employs a node having a tilt mechanism mechanically coupled to first and second pylons, each of the first and second pylons being coupled to a motor and a rotor, the method comprising:
providing the first pylon above the wing to extend a first motor and a first rotor above the wing; and
providing the second pylon below the wing to extend a second motor and a second rotor below the wing,
wherein the first pylon is substantially identical to the second pylon, the first motor is substantially identical to the second motor, and the first rotor is substantially identical to the second rotor.

14. The method according to claim 13, further comprising a second node having a second tilt mechanism mechanically coupled to third and fourth pylons, each of the third and fourth pylons being coupled to a motor and a rotor, the method comprising:
providing the third pylon above the wing to extend a third motor and a third rotor above the wing; and
providing the fourth pylon below the wing to extend a fourth motor and a fourth rotor below the wing,
wherein the third pylon is substantially identical to the fourth pylon, the third motor is substantially identical to the fourth motor, and the third rotor is substantially identical to the fourth rotor.

15. The method according to claim 14, wherein the first node and the second node are mechanically coupled to the wing on opposite sides of a fuselage.

16. The method according to claim 15, wherein the first node and the second node are force and torque balanced about an axis of rotation of the fuselage.

17. The method according to claim 13, wherein the first rotor and the second rotor are provided entirely within the wingspan to generate airflow that passes above and below the wing.

18. The method according to claim 14, wherein all pylons are substantially identical, all motors are substantially identical, and all rotors are substantially identical.

19. The method according to claim 14, wherein the first and second tilt mechanisms are actuated to enable vertical flight.

20. The method according to claim 14, wherein the first and second tilt mechanisms are actuated to enable horizontal flight.
